(19) United States
(12) Patent Application Publication
(10) Pub. No.: US 2002/0167149 A1
(43) Pub. Date: Nov. 14, 2002

(54) Wheelchair having decorative artwork

(76) Inventor: Joan M. Mavrinac, Pittsburgh, PA (US)

Correspondence Address: Arnold B Silverman Esquire, Eckert Seamans Cherin & Mellott LLC, 44th Floor, 600 Grant Street, Pittsburgh, PA, 12219-2788, US

(21) Appl. No.: 09/532,294

(22) Filed: Mar. 23, 2000

(51) Int. Cl. B62M 1/14

(52) U.S. Cl. 280/250.1

(57) ABSTRACT

A wheelchair has a seat, a backrest, at least one footrest, and a plurality of wheels. The wheelchair is artistically decorated in one or more ways so as to have a more pleasant appearance. In one embodiment, a protective housing defines an interior chamber within which artwork is provided. At least a portion of the protective housing is transparent to permit viewing of the artwork from the exterior thereof. Such a housing may be positioned on the back of the backrest, on a footrest, on an armrest, and on the wheels. The housing preferably is closed and locked so as to resist undesired removal of artwork and has an open position to permit insertion or removal of artwork. The housing is preferably sealed so as to resist undesired entry of rain, snow, and other foreign matter. In the decorated wheel embodiment, the wheels may have art elements attached to spokes. Such elements may have a plurality of surfaces which are decorated by artwork. A wheel disk may be provided such that a different artistic impression is presented when the wheels are in motion or viewed from different angles.

### BACKGROUND OF THE INVENTION

1. Field of the Invention

The present invention relates to a wheelchair construction which has artwork secured thereto and, more specifically, in some embodiments has constructions which facilitate physical removal of artwork therefrom and substitution of other artwork therefor.

2. Description of the Prior Art

It has been known for many decades to provide wheelchairs for people who due to permanent or temporary physical impairment are not able to walk to the extent required in order to lead a normal lifestyle. Such wheelchairs typically have a seat for an individual occupant, and a pair of relatively large diameter wheels disposed on opposite sides of the seat with an outer ring which is manually engaged for applying a force to move the wheelchair in either a forward or rearward direction. The wheelchair may also have a pair of rotatable, relatively small front wheels which not only provide stability, but facilitate going in the desired direction. Wheelchairs also typically have a pair of armrests, a pair of footrests or a single footrest structured to support both feet, and a seat and backrest with the backrest having a pair of rearwardly projecting handles at the upper portion thereof to enable someone other than the user to push the wheelchair.

It has also been known to provide motorized wheelchairs which typically operate with a storage battery as the source of energy serving to energize a suitable motor which the occupant of the chair controls through a suitable control panel.

It has also been known to provide wheelchairs with a suspension to absorb shocks so that rough terrain can be accommodated without transmission of undesired forces to the occupant. Such a wheelchair is sold under the trade designation “QUICKIE XTR” by Sunrise Home Healthcare Group.

It has been known to provide folding wheelchairs which can more easily be placed in vehicles for transport to and from a location where they will be used.

One problem that has existed in connection with the numerous types of known wheelchairs is the fact that they tend to be of rather drab appearance thereby contributing an additional negative to what is otherwise an unpleasant medical necessity. This is particularly true in cases where children are involved. Frequently, wheelchairs have a dominant appearance of black even though seat covers or portions may have another color or even a blend of colors.

In spite of the foregoing, there remains a very real and substantial need for a wheelchair having a more pleasant, aesthetically appealing appearance, while continuing to function for its intended purpose.

### SUMMARY OF THE INVENTION

The above-described need has been met by the wheelchair of the present invention wherein in one embodiment a protective housing defines an interior chamber for receipt of artwork with artwork being disposed within the housing. The housing has at least a portion which is transparent to permit viewing of the artwork therethrough. The housing has an open position wherein artwork may be inserted or removed and a closed position which resists such removal.

The housing may be secured to the rear of the backrest (or a backpack secured thereto), the armrests, or the footrests.

In another embodiment, the artwork may be secured to a plurality of wheels of the wheelchair and/or the manually engageable ring. For convenience of reference herein, reference to artwork being secured to the “wheel” or “wheels” shall include at least one of the wheels and/or manually engageable ring. The wheel artwork may take the form of individual elements secured to the spokes with the elements having a plurality of surfaces decorated. Another form of preferred wheel decoration is to have disks secured thereto which present kinetic art effects or employ holograms to create a varying appearance.

It is an object of the present invention to provide an aesthetically pleasing wheelchair as a result of the use of artwork secured to the chair or an accessory which is secured thereto.

It is a further object of the present invention to secure such artwork to the wheelchair in such a fashion as to resist theft of or damage to the artwork.

It is a further object of the present invention to provide a wheelchair receiving artwork housing with an interior space such that rain, snow and other undesired foreign matter cannot get into the housing to damage the artwork.

It is a further object of the present invention to provide security means which resist undesired tampering with the artwork or theft of the same.

It is another object of the invention to provide such artwork secured to a plurality of locations on a wheelchair so as to enhance the appearance as viewed from many directions.

It is another object of the invention to provide artwork which may be created separately and then secured to the wheelchair.

These and other objects of the invention will be more fully understood from the following description of the invention on reference to the illustrations appended hereto.

### BRIEF DESCRIPTION OF THE DRAWINGS

FIG. 1 is a partially schematic perspective view of a front portion of a wheelchair of the present invention.

FIG. 2 is a partially schematic perspective view of a rear portion of a wheelchair of the present invention.

FIG. 3 is a cross-sectional illustration taken through 3-3 of FIG. 2.

FIG. 4 is an elevational view showing a portion of an artwork display housing of the present invention.

FIG. 5 is an illustration of artwork secured to spokes of a wheelchair wheel of the present invention.

FIG. 6 is an elevational view showing artwork over a portion of the spokes of a wheelchair wheel of the present invention.

FIG. 7 is an elevational view of a form of decorated wheel disk for securement to a wheelchair wheel of the present invention.

FIG. 8 is a cross-sectional view of the wheel disk of FIG. 7 taken through 8-8.

### DESCRIPTION OF THE PREFERRED EMBODIMENTS

As employed herein, the term “artwork” means a visually perceptible two or three-dimensional graphic work having one or more graphic components in one or more colors with or without letters or numbers and intended to function primarily for decorative purposes.

A “wheelchair” means conventional wheelchairs, whether power driven or manually driven, as well as modified versions thereof, which are wheeled vehicles structured to receive a single person in a seated position to facilitate transport of such person.

The term “backrest” as employed herein shall refer to the backrest portion of the wheelchair with particular emphasis on the rear surface thereof as well as flexible or rigid containers, such as backpacks, permanently or demountably secured adjacent to the rear portion thereof having an interior for holding articles other than artwork and to which artwork or a housing for artwork of the present invention may be secured.

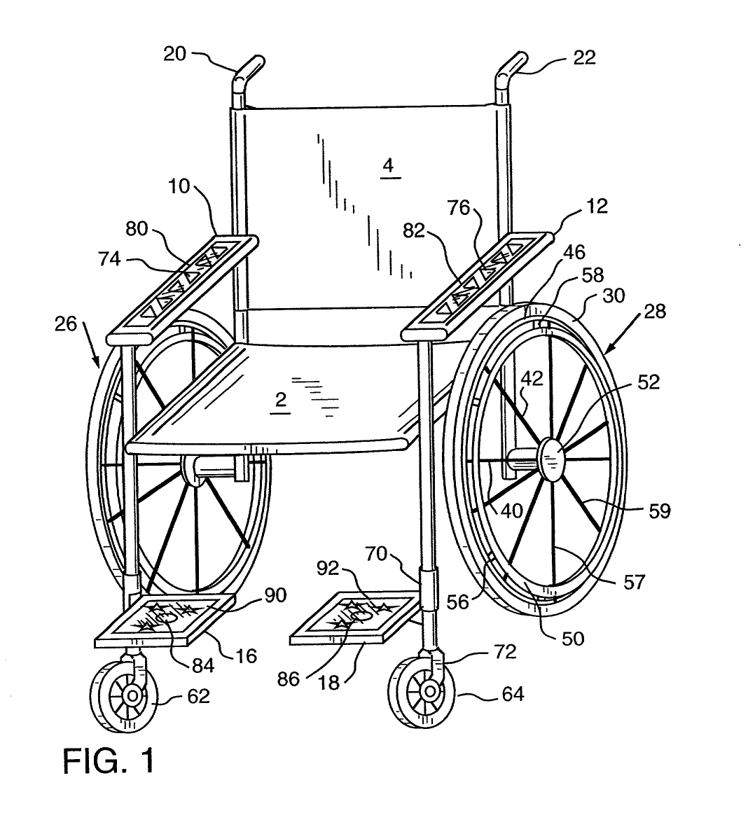

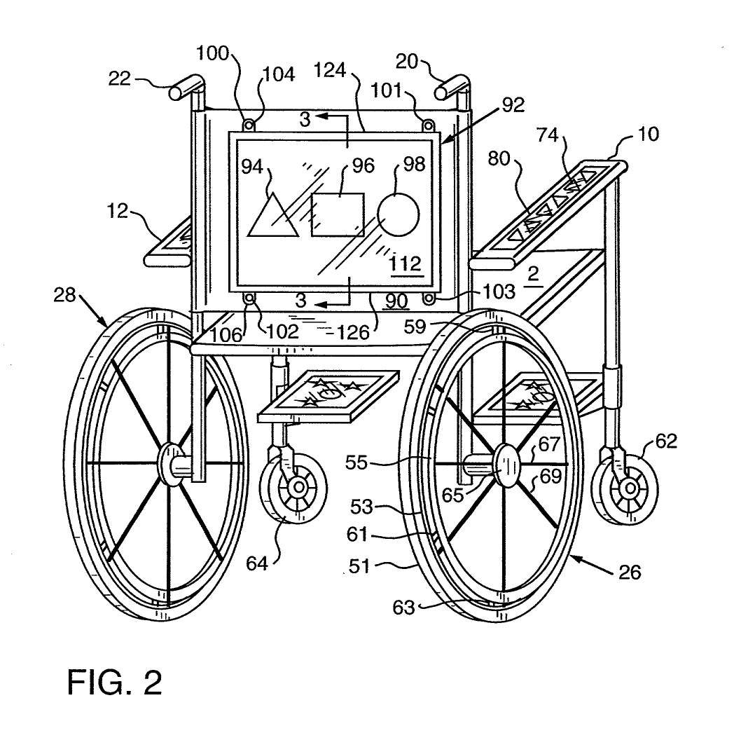

Referring more specifically to FIGS. 1 and 2, there is shown a wheelchair having a seat 2, a backrest 4, a pair of armrests 10, 12 and a pair of footrests 16, 18. The backrest 4 terminates in a pair of manually engageable rearwardly extending handle members 20, 22 which are structured to be engaged by one standing behind the wheelchair who may push the wheelchair. The wheelchair has a pair of large rear wheels 26, 28. As shown in connection with who may push the wheelchair wheel 28, the wheel 28 has a tire 30 and a plurality of spokes such as 40, 42, 57, 59 engaging a hub 52 and a rim 46. A manually engageable ring 50 is secured to rim 46 by a plurality of connectors, such as 56, 58. In a manually powered wheelchair shown in FIGS. 1 and 2, the rim 50 is adapted to be engaged by the user so as to convert rotational forces user-applied to the ring 50 in a forward or rearward direction into responsive rotation of the tire 30 and movement of the wheelchair. Wheel 26 has tire 51 with associated rim 53 and ring 55. Spokes, such as 67, 69, for example, are secured to the rim 53 and hub 65. Ring 55 has a plurality of connectors, such as 59, 61, 63 secured to rim 53.

As shown in FIG. 1, the wheels 26, 28 are designed to rotate about their horizontal axis of rotation, but not to rotate in any other direction. The forward smaller wheels 62, 64 are structured to rotate both about their horizontal axis of rotation in moving forwardly or rearwardly or at an angle and also to rotate about the support member 70 which is secured to fork member 72 to facilitate steering the wheelchair in the desired direction.

The armrests 10, 12, as shown in FIGS. 1 and 2, have artwork such as 74, 76, which in the form shown are a series of triangles, secured thereto. These may be suitably framed as in housing members 80, 82 to protectively enclose the same.

Similarly, artwork 84, 86 may be applied to footrests 16, 18, respectively, within a frame or housing 90, 92 in a manner to be described hereinafter.

Referring now to FIGS. 2 and 3, the rear portion of the backrest has a surface 90 to which is secured a housing 92 which for purposes of example contains artwork 94, 96, 98 in the form of geometric shapes. Each of the elements 94, 96, 98 can be of different colors. The housing 92, as shown in FIG. 3, may be secured to the backrest 4 by any suitable means such as mechanical fasteners 100, 102 which, in the form shown, are screws passing through eyelets 104, 106, respectively. Additional eyelets such as 101, 103 are employed in the form shown. In the form shown, the housing 92 defines an interior chamber 110 within which is a substrate 112 on which the artwork is provided. If desired, the interior chamber 110 may be of reduced depth so as to be in more intimate contact and restraining position with respect to the artwork containing substrate 112. If desired, a suitable, elongated continuous sealing gasket such as resilient member 120 may be provided adjacent to the housing walls 122, 123, 124, 126 such that the housing will resist undesired entry of rain, snow and other foreign matter. It will be appreciated that by employing mechanical fasteners, such as 100, 102, ready access to the artwork 94, 96, 98 on substrate 112 on the part of casual passers-by is resisted, but with a suitable tool, the artwork containing substrate 112 may be replaced with other artwork by the wheelchair owner or user. It will be appreciated that outer wall 118 is transparent so as to permit ready viewing of the artwork 94, 96, 98 from the rear exterior of the wheelchair.

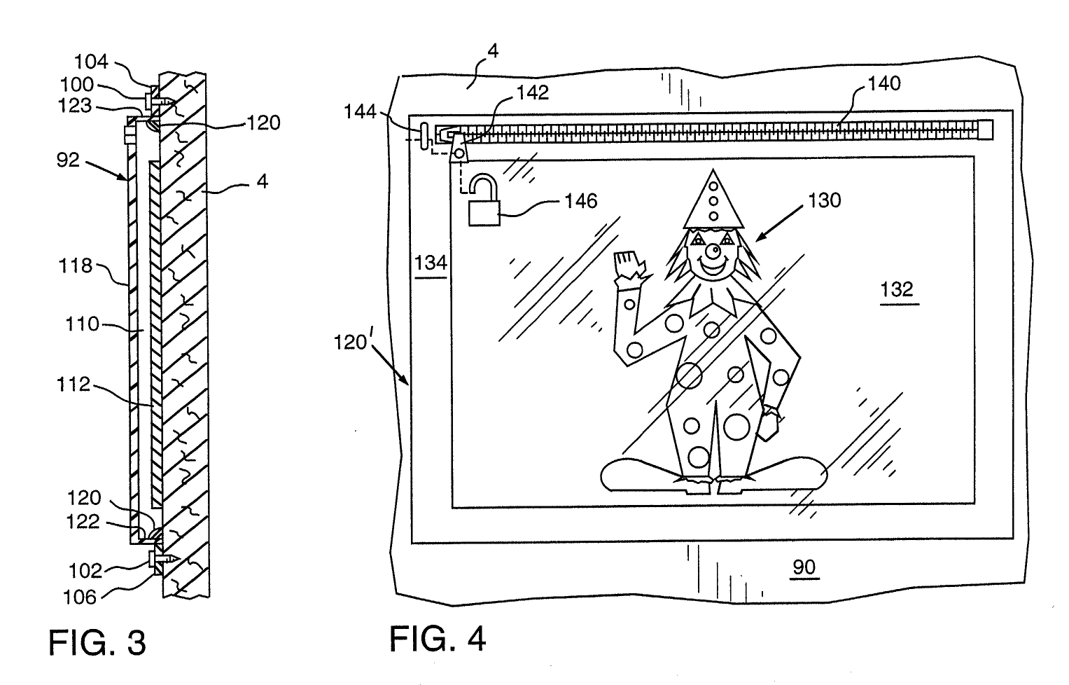

FIG. 4 illustrates an alternate embodiment of the housing which may be secured to the backrest by any suitable means. In this embodiment, the housing 120′ may be secured to the backrest 4 by a suitable adhesive (not shown). In this embodiment, the artwork 130 is in the form of a clown which is viewed through a transparent panel 132 which forms a part of wall 134 of housing 120′. Access to the interior of the housing is obtained by zipper 140. Security against undesired tampering may be achieved by securing the zipper operating member 142 to a keeper member 144 through lock 146.

The housing secured to the backrest rear surface 90 may take the form of flexible or substantially rigid backpack. It may be removably secured to the backrest rear surface by cooperating snap members.

It will be appreciated that similar types of housings may be employed in creating the artwork shown on armrest 10, 12 and footrest 16, 18 in FIGS. 1 and 2. Also, for example, the artwork bearing substrate or housing containing the substrate may be removably secured to the wheelchair by interlocking fasteners such as the hook and loop fasteners sold under the trade designation “VELCRO.”

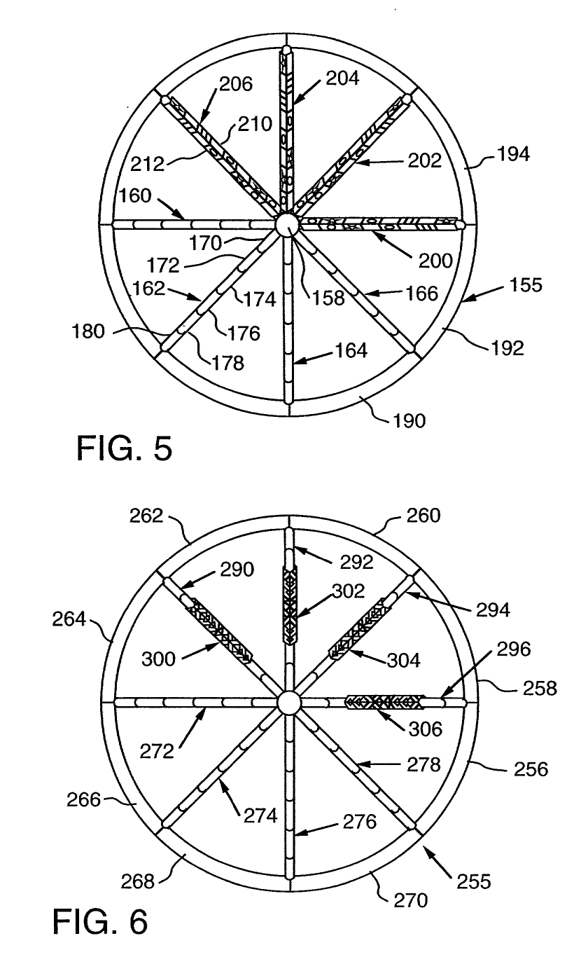

FIG. 5 shows a spoked wheel 155 such as wheels 26, 28 of FIGS. 1 and 2. The wheel 155 has hub 158 and rim 190 having a first type of spoke 160, 162, 164, 166 which has been decorated by having a series of radially positioned segments of different artwork such as different color, such as segments 170, 172, 174, 176, 178, 180, on spoke 162, for example. Similar segments which may vary in color or pattern are provided on spokes 160, 164, 166. Such spoke decorations may also be provided on the spokes of wheels 26, 28, shown in FIGS. 1 and 2, if desired. This spoke and ring artwork may be made of any suitable material such as rubber or synthetic resins, if desired, and may be secured in place adhesively or by mechanical means. The outer periphery of wheel 155 may be provided with different colors or patterns in each of the arcs between the spokes, such as a first color for arc 190, a second color for arc 192, and a third color for arc 194, for example. If desired, all of the spokes may be decorated in the manner of 160, 162, 164, 166. An alternate approach to spoke decoration is provided in the spokes which are covered by multi-faced elements. A first surface 210 of spoke cover 206, which may be of generally square cross-section, is decorated with a first pattern of artwork and a second one with a second surface 212 of artwork.

It will be appreciated that as the wheel rotates about hub 158, a decorative pattern of changing appearance will be provided depending upon the angular velocity of the wheel 155.

Referring to FIG. 6, a rim 255 having adjacent arcs 256, 258, 260, 262, 264, 266, 268, 270 of different colors or artwork patterns may be provided. The spokes 272, 274, 276, 278 may be provided with a single pattern or color differing from those of adjacent arcs. The spokes 290, 292, 294, 296, in the form shown, each have multi-surface elements, such as 300, 302, 304, 306, which are of lesser axial extent than the respective spokes 290, 292, 294, 296 on which they are affixedly secured. These elements could also be employed on wheels 26, 28 which are shown in FIGS. 1 and 2, if desired.

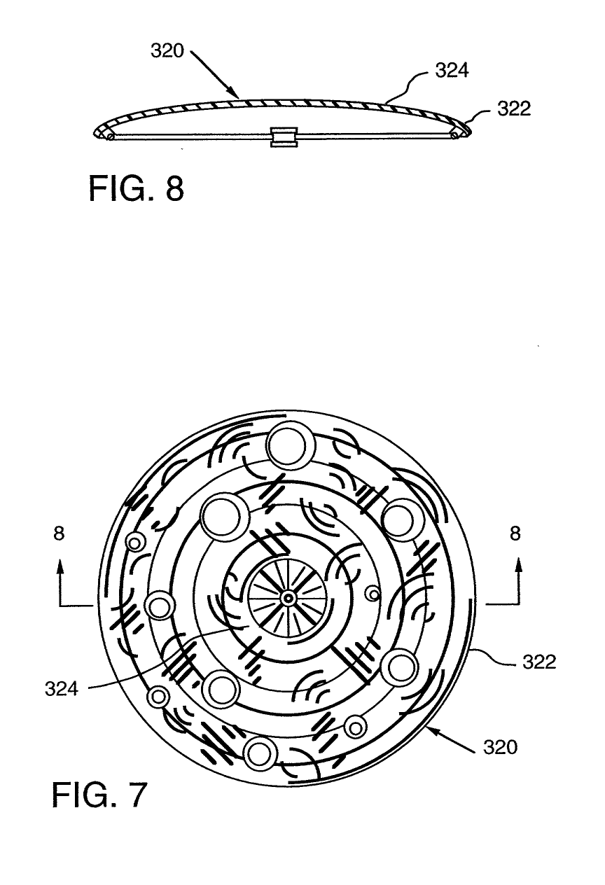

Referring to FIGS. 7 and 8, there is shown a hubcap or disk wheel 320 which is generally circular in plan and may be considered as being hollow and domed outwardly of the page with the peripheral configuration at the outer rim 322 being generally circular and the center domed portion 324 projecting highest beyond the level of the rim. The artwork shown on this disk 320 is preferably kinetic in that it changes appearance substantially when the wheel-mounted disk 320 is subjected to rotation as the wheel rotates. The artwork may be so designed as to create certain unique pictures or patterns as the wheel turns. Also, holograms may be provided on the exterior surface of the disk to cause a change in appearance of the disk or wheel cover 320 as a person moves with respect to a stationary wheel having the disk 320 mounted thereon. These disk wheels 320 may be employed as hubcaps on wheels 26, 28, and wheels 62, 64. They may also be employed to cover larger areas of wheels 62, 64 or wheels 26, 28, if desired.

If desired, artwork in the form of tubular rubber or plastic slit elements may be secured over all or a portion of manually engageable wheel rings such as 50, 55 shown in FIGS. 1 and 2.

While for simplicity of disclosure, the preferred securement of housings such as shown in FIGS. 1-4 to the backrests, armrests and footrests has been shown they may be secured to other portions of the wheelchair, if desired. For example, housings may be secured to one or more wheels.

It will be appreciated, therefore, that the present invention provides an effective means for establishing artwork on one or more portions of a wheelchair so as to enhance the cheerfulness and attractiveness of the wheelchair. All of this can be accomplished while providing protection from rain, snow and other foreign matter, as well as security against tampering with the artwork or thievery of the same.

Whereas particular embodiments of the invention have been described herein for purpose of illustration, it will be appreciated by those skilled in the art that numerous variations of the details may be made without departing from the invention as described in the appended claims.

I claim:

1. An artistically decorated wheelchair comprising
a wheelchair having a seat, a backrest, at least one footrest, a pair of armrests, a plurality of wheels,
at least one protective housing defining an interior chamber for receipt of artwork secured to said wheelchair,
artwork disposed within said interior chamber of said housing, and
said protective housing having at least a portion which is transparent to permit viewing of said artwork therethrough.

2. The wheelchair of claim 1 including
said housing being generally sealed so as to resist entry of undesired foreign matter into said interior chamber.

3. The wheelchair of claim 1 including
said artwork being removably secured within said protective housing interior chamber.

4. The wheelchair of claim 2 including
said housing having an open position for facilitating insertion and removal of said artwork and a closed position for resisting removal of said artwork.

5. The wheelchair of claim 4 including
a said protective housing being secured to a rear portion of said backrest.

6. The wheelchair of claim 4 including
a said protective housing being secured to at least one said footrest.

7. The wheelchair of claim 5 including
a said protective housing being secured to at least one said armrest.

8. The wheelchair of claim 2 including
said housing having locking means for resisting undesired access to said artwork.

9. The wheelchair of claim 1 including
said artwork secured to a plurality of said wheels.

10. The wheelchair of claim 1 including
said artwork including a plurality of elements secured to spokes of at least some of said wheels.

11. The wheelchair of claim 1 including
said artwork including a decorated disk secured to at least some of said wheels.

12. The wheelchair of claim 1 including
said decorated disk secured as a hubcap.

13. The wheelchair of claim 1 including
said wheelchair having manually engageable rims secured to a pair of said wheels, and
artwork secured to said rims.

14. The wheelchair of claim 1 including
at least some of said wheels having a plurality of generally radially oriented spokes, and
artwork secured to said spokes.

15. An artistically decorated wheelchair comprising
a seat, a backrest, at least one footrest, a pair of armrests, a plurality of wheels, and
at least two of said wheels having artwork secured thereto which creates a varying image as said wheels rotate.

16. The wheelchair of claim 15 including
said artwork including a plurality of decorative spoke attachments.

17. The wheelchair of claim 15 including
said artwork having decorated wheel disks.

18. The wheelchair of claim 15 including
said artwork including holograms.

18. The wheelchair of claim 16 including
said spoke attachments having a plurality of surfaces having artwork thereon.

19. The wheelchair of claim 15 including
a protective housing containing artwork and
having at least a portion of which is transparent to permit viewing of the artwork therethrough.

20. The wheelchair of claim 17 including
said disks secured to the wheels as hubcaps.

21. The wheelchair of claim 15 including
said wheelchair having manually engageable rims secured to a pair of said wheels, and
artwork secured to said rims.

22. The wheelchair of claim 15 including
at least some of each said wheels having a plurality of generally radially oriented spokes, and artwork secured to said spokes.
